(19) United States
(12) Patent Application Publication
(10) Pub. No.: US 2016/0328716 A1
(43) Pub. Date: Nov. 10, 2016

(54) COMMUNICATION DEVICE COMPRISING A LUMINOUS ACTIVATION SENSOR

(71) Applicant: GEMALTO SA, Meudon (FR)

(72) Inventors: Stephane TOUVET, Meudon (FR); Michel THILL, Meudon (FR); Evangelos SPYROPOULOS, Meudon (FR); Guillaume CAMMAS, Meudon (FR)

(73) Assignee: GEMALTO SA, Meudon (FR)

(21) Appl. No.: 15/109,367

(22) PCT Filed: Dec. 3, 2014
(86) PCT No.: PCT/EP2014/076348

§ 371 Date: Jun. 30, 2016

(30) Foreign Application Priority Data
Dec. 30, 2013 (EP) 13306894.0
Jan. 14, 2014 (EP) 14151152.7

(51) Int. Cl. G06Q 20/40; H04L 29/06; G06K 19/07

(52) U.S. Cl. CPC G06Q 20/4018; G06K 19/0728; H04L 63/0853; G06Q 2220/00

(57) ABSTRACT

The communication device 1 comprises a memory M for storing a numeric key and a diversification algorithm; a calculator D for generating an identification code from at least the numeric key and the diversification algorithm; a display for displaying the identification code generated 101, 102, 103 by the calculator. The communication device further comprises a light sensor 11 for receiving a light signal 30.

### FIELD

The field of the invention relates to devices for securing transactions, particularly by means of the generation of a security code. More precisely, the field of the invention applies to the area of bank cards with displays comprising modules to generate codes for securing transactions.

### BACKGROUND

Currently, solutions exist already for making bank cards that can secure transactions by means of simple identification of the card by its number, date of validity and holder by telephone or via the Internet.

A simple means of securing a transaction is the three-digit security code, also called CSC, CVV, CVC or V-code or CCV. The authors of this application use the widespread acronym that is known to those skilled in the art, CVV, which stands for: Card Verification Value.

One of the problems of this means of securing is that the code is displayed statically on one of the sides of the card. As a result, the code can be read easily by a third party and be used jointly with the other information collected on the card.

To improve the security of such transactions using bank cards, making the CVV dynamic is known. The dynamic CVV is a code that varies over time, which is displayed on the card. The variable code is supplied by a generator of the synchronised pseudo-random type with a server that makes it possible to verify the authenticity of the code depending on the date and time of the transaction.

However, the use of dynamic CVV raises a few problems. A first problem comes from personalisation, which involves the introduction of a numeric encryption key in a memory of the display module before it is integrated into a smart card.

This solution is complex from the organisational viewpoint because it is necessary to multiply the operations for tracing the modules that generate and display CVV codes with the associated card numbers. The card numbers are not necessarily known at this point, that is during the definition of the numeric key in the module, and so the tracking and allocation of modules becomes complex to implement.

In one alternative, it is possible to have external contactors for personalising the module that generates CVV codes. Once the card is manufactured, personalisation takes place with an external device that makes it possible to personalise an encryption key in the module. However, this solution has a drawback from the viewpoint of the use of the card, because the contactors may not be convenient for the user. Besides, contactors have an adverse effect on the aesthetic appearance of the card.

In another alternative, the module that generates the CVV codes may be associated with an RF module that makes it possible to set up a link with an external device that allows personalisation after the card is made. However, this solution is costly and difficult to implement, particularly with contactless bank cards where one of the modules could create interferences with the other module.

In another alternative, the module that generates CVV codes can be coupled with the microchip already integrated on a card via the ISO contacts. But this solution is difficult from the point of view of integration. Further, it does not make it possible to dissociate the two components of the card and make them independent. The independence of the two components helps secure the environment of the card and makes it more difficult to hack.

A second problem is that, even with a dynamic CVV code, it is not possible to do away with the theft of the information displayed on the smart card. For example, when the card can be seen by a third party, that party can collect information, including the CVV code displayed dynamically, and use it during the time of validity of the code.

To that end, existing solutions propose means to limit such theft of information. For example, it is possible to have a button for generating the display of the CVV code on the display only when that is needed. That solution has the drawback of being difficult to integrate on a smart card and the button may be inconvenient for a user. Besides, it may be activated by error or by a person with malicious intent who is temporarily in possession of the card.

Another solution consists in periodically triggering the display; that solution may be costly in terms of power consumption. Besides, this solution may have adverse effects during transactions, making it necessary to wait for the time when the code will be displayed. If the waiting time for confirming the payment is too long, the solution is not viable.

### SUMMARY OF THE INVENTION

The invention makes it possible to overcome the aforementioned drawbacks.

One object of the invention relates to a communication device comprising:
a memory for storing a numeric key and a diversification algorithm;
a calculator for generating an identification code from at least the numeric key and the diversification algorithm;
a display for displaying an identification code generated by the calculator.

Further, the communication device according to the invention comprises a light sensor that can receive and/or detect light.

Advantageously, the light sensor is intended to receive a light signal, where the communication device carries out a device initialisation function, which initialisation function comprises the following:
decoding of a sequence of data modulating a light signal received by the light sensor;
storing of the numeric key included in the decoded numeric sequence.

One advantage is to allow the personalisation of a device such as a smart card in a secure and simple manner using an optical type emitter.

One advantage is to facilitate the traceability of a device for communication with a smart card when said communication device is integrated in a card when it is manufactured. The numeric key may then be associated with a card number after it is manufactured, at the time of the final personalisation of the card. Thus, the communication device is advantageously a module that generates identification codes, such as a CVV type code, the numeric key of which constitutes an initialisation seed of a diversification algorithm.

In one embodiment of the invention, the calculator makes carries out a function of activating the display after the acquisition of the light intensity received by the light sensor for a predefined time.

One advantage of that function is to make it possible to obtain delayed code display. That display delay may be understood as a minimum activation time, which may thus offer protection from the code being copied by a third party.

The quantity of light received may be received light intensity. When that light intensity is integrated over a time scale, it may define a received quantity of energy.

The quantity of light received over a predefined time may be measured depending on the embodiments by the light sensor directly or by the calculator or jointly by those two components. To that end, the communication device may include a clock, and the calculator can trigger a time counter for measuring the luminous flux for a given period of time.

The communication device can compare the light intensity received at each instant during the acquisition time or in another embodiment, the communication device can compare the total energy received during the acquisition time with an energy limit.

Advantageously, the communication device comprises a battery for powering the display and the calculator. That makes it possible to make the communication device independent. Its low consumption enables it to offer a minimum life beyond the life generally attributed to a smart card with an expiry date.

Advantageously, the calculator can generate the identification code from a public piece of data and the numeric key stored in the memory.

Such generation makes it possible to increase the security of the code displayed and its validity.

Advantageously, the public piece of data is date data. In that case, the communication device comprises a clock that can deliver a date.

In one embodiment, the communication device according to the invention comprises a clock for determining time intervals, in which the display allows the display of an identification code generated by the calculator. The display of an identification code is advantageously displayed after a predetermined security time has elapsed after the detection of light.

Advantageously, a new identification code is generated periodically.

Advantageously, the display of the identification code is kept displayed during a display time.

When that solution is selected, the server also comprises a clock for checking the identification code, such as a CVV code, and its match with the data corresponding to the piece of date data that has made it possible to generate the dynamic CVV code. The server may be configured to accept a certain level of tolerance, particularly vis-à-vis a time drift of the clock used in the communication device.

Advantageously, the display allows electrophoretic display. This solution makes it possible to reduce power consumption, particularly thanks to the non-volatile status of the data displayed.

Advantageously, the first predetermined time ranges between 10 minutes and 2 days and the second predetermined time ranges between 1 and 10 minutes.

Another object of the invention relates to a smart card comprising a communication device according to the invention.

In one embodiment of the invention, the display of the communication device is placed on the same side of the card as the light sensor.

Another object of the invention relates to a method for carrying out a transaction from a smart card including a device comprising:
a memory for storing a numeric key and a diversification algorithm;
a calculator for generating an identification code from the numeric key;
a display for displaying an identification code generated by the calculator;
a light sensor for receiving and/or detecting light.
Said method comprises the following steps:
the smart card is positioned so that the light sensor is exposed to a light source for a minimum time;
a code is displayed on the display after the exposure for the minimum time.

One advantage of such a method is to secure the identification code validation operation by reducing the time during which it could be exposed to a third party.

Another object of the invention relates to a method for personalising a smart card comprising a card number, wherein said method comprises:
a communication device according to the invention is allocated to a card number, wherein an identifier of said communication device is stored on a remote server and -associated with said card number;
the assembly of the communication device on said smart card;
the allocation of a numeric key to a communication device associated with a card number;
the numeric key is transferred by the reception on the light sensor of a light signal modulated by a sequence of data during the final personalisation of the smart card.

The benefit of such a method is that it is no longer necessary to trace the modules that generate the identification code with their card by associating them from the time they are manufactured. It is understood that in such a case, the communication device according to the invention is a module that generates CVV codes. The CVV generation module is personalised during final personalisation, and the initialisation seed is easily matched with the account number that is entered on the card at the same time.

Advantageously, the transfer of the numeric key includes the emission of a light signal modulated by a sequence of data on a light sensor of the communication device.

### BRIEF DESCRIPTION OF DRAWINGS

Other characteristics and benefits of the invention will become clear in the detailed description below, by reference to the attached figures, which represent the following:

FIG. 1: the back of the smart card comprising a communication device according to the invention;

FIG. 2: the front of the smart card comprising a communication device according to the invention;

### DESCRIPTION

In the description below, a ‘luminous activation sensor’ is generally called a ‘light sensor’.

In this application, an ‘encryption key’ may be called ‘a numeric encryption key’ or a ‘numeric key’.

This description illustrates an embodiment in which the communication device is a dynamic CVV code generator. More generally, in this invention, a code generated from a numeric key that may for example be of the CVV type is called an identification code.

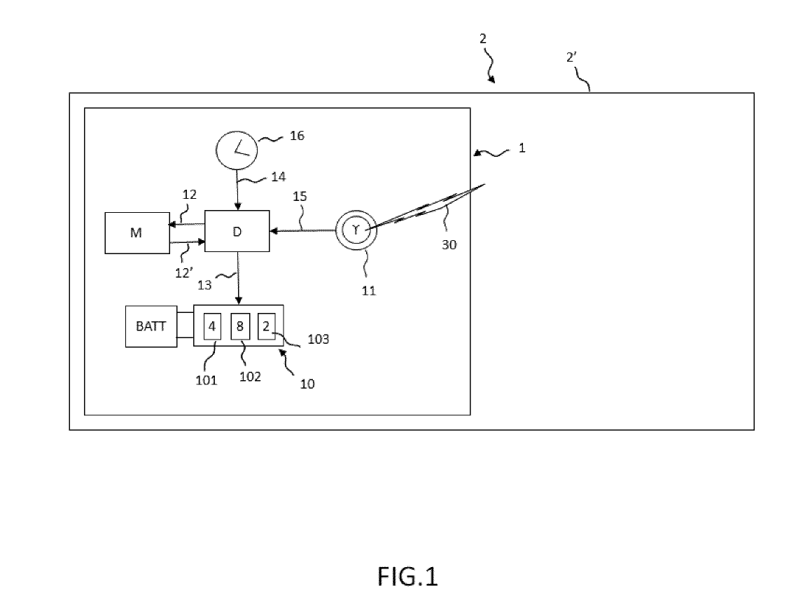

FIG. 1 represents a smart card 2 presented on its side conventionally named its back 2′. That back comprises a communication device 1 according to the invention.

The device according to the invention comprises a light sensor 11 capable of receiving a luminous flux 30.

The light sensor may be a light-sensitive element such as a phototransistor, a photodiode or a photo-electric cell. Preferably, the light sensor 11 is placed on the same side of the card as the display 10, when the communication device is integrated into a smart card.

When the communication device is integrated into a smart card, the light sensor may be placed under a translucent part to allow homogeneity of the surface with the surface of a smart card. In one embodiment, the translucent part forms part of the surface of the card. The translucent part thus protects the light sensor from contact by the hands or rubbing that may occur when the card is put in a pocket or a wallet.

The light sensor 11 is coupled with a calculator D. A display 10 makes it possible to display an identification code of the dynamic CVV code type. A memory M is used to store a numeric encryption key K and a diversification algorithm. Besides, a clock 16 makes it possible to provide time data. In one embodiment of the invention, the numeric key and the time data make it possible to generate an identification code using the calculator D. Generation may for example be according to a known diversification algorithm that associates a unique identification code depending on the date or generates a new code on given dates. That identification code is valid for a predefined time corresponding to a time interval between two identification code generations. The algorithm for diversifying the identification code from the secret, made up by the numeric key, and a time, is executed by the calculator D. Each identification code generated is thus different from a previous code thanks to the time data.

There are other alternatives for generating an identification code from an encryption key and public data. The piece of public data may for example be a number of events, for example when a card bearer increments an events counter by taking action. The action may for example be taken each time card utilisation is detected. The counter is also evaluated by the server, for example by counting the number of transactions. In that case, tolerance must be accepted by the server. The code may thus be validated when the transaction is terminated.

In that sense, the communication device of the invention is a generator of identification codes, for example, dynamic CVV codes. The light sensor allows it to be initialised by defining a seed and storing it in the memory of the identification code generator. That last step may be understood to be a step where the smart card is personalised, and is only carried out once in principle. Further, the light sensor makes it possible to test the reception of light intensity for a given time in order to activate or not the display of the code generated when the card is used.

The display and the calculator can be powered by a battery BATT for displaying the identification code. When that code comprises 3 digits 101, 102, 103 as represented in FIG. 1. The illustrated sequence represents the three-digit code: “482”.

In a first embodiment of the communication device according to the invention, a first function consists in decoding a light sequence. The signal containing the numeric data that modulate the first signal is called the ‘first luminous signal’. This first function is used for initialisation, during the personalisation of the card, and makes it possible to define, transmit and store the numeric encryption key in the memory M. In principle, it is only carried out once.

The encryption key defines a seed making it possible to make the identification code variable. The seed may possibly include other information if necessary, such as an identifier. In one alternative embodiment, the reception of the encryption key can be validated in return by a display on the screen or by LED.

In a second embodiment of the communication device according to the invention, a second function consists in activating the display 10 after a predetermined time of exposure of the sensor 11 to the light. One advantage is to benefit from two functions at different times in the life of the smart card. The two functions are supported by such an identification code generator according to the invention.

In the usage phase, the second function of the light-sensitive element is to detect that the card has been exposed to light at the display for a determined time in order to authorise the display of the identification code.

The second luminous signal is the signal that makes it possible to activate the display, that is for a light intensity received during a certain time, the calculator D is capable of activating the display of a code on a display 10. That second function is used every time the user needs an identification code. In that case, the user exposes the side of the smart card 2 comprising the sensor to the light 11 for a certain time. In the case of FIG. 1, the side with the sensor is the back of the smart card.

The two embodiments are supported by the communication device of the invention. They are activated at different times. Regarding the first function, it is activated when the card is personalised, thus when the card is manufactured and configured. Regarding the second function, it is activated with each new use by a card bearer in order to supply a new identification code.

Let us detail the working of the first function. In one alternative embodiment, the light sensor comprises a component that makes it possible to demodulate the light signal and extract a numeric sequence from it. In a second alternative, the calculator comprises an interface adapted to receive an analogue signal and convert it into a numeric signal. The communication device according to the invention thus comprises an analogue to digital signal converter that may be integrated into the light sensor 11 or the calculator D. Possibly, the converter may be a -component in its own right located in the chain of reception between the light sensor 11 and the calculator D.

In alternative embodiments, components that can quantify or normalise the signal received may be used in the communication device according to the invention.

When the converter is integrated into the sensor 11, numeric data are transferred via the connection 15 to the calculator D.

The calculator D makes it possible to extract information from the numeric sequence received such as the numeric encryption key. That key is then stored in a memory M via a connection 12. The example in FIG. 1 represents an embodiment of a possible implementation.

During the personalisation phase, an appropriate emitter that can send a sequence of information modulating a light signal may be specially used during this step. The emitter is positioned opposite the light sensor.

Let us detail the working of the second function.

When the user wishes to generate a dynamic identification code, for example a three-digit code to secure a transaction, they place side 2′ of the smart card 2 so that the sensor 11 is exposed to light for a given time. That time may be a few seconds.

The light sensor acquires a luminous flux 30 and measures the received luminous intensity integrated over a given period of time. When the intensity exceeds a predefined limit during the given time, a signal may be transmitted either directly to the display 10 or to the calculator D. That last solution is the mode described in FIG. 1.

The calculator D then activates the display of an identification code. Such activation may be understood as “display authorisation”.

To carry out the second function, unlike the first one, the light signal received does not necessarily modulate a data sequence. Only a duration or level of light energy is necessary for activating the display of an identification code.

In one embodiment, a clock makes it possible to determine the time intervals and generate new codes, regularly or pseudo-randomly over time.

That solution makes it possible to increase the usage security of a smart bank card, for example. Each identification code displayed is then a single-use code.

A single-use identification code is displayed after the end of a predetermined security time so as to not expose the identification code too rapidly to a third party.

Further, once the identification code is displayed, an optional function may be implemented so as to maintain the display of the code for a certain extended time. That function, known as the ‘freeze’ function, freezes the display of a new identification code while the previous identification code is being read.

In one embodiment, the identification code is generated from the encryption key and a piece of time data. The encryption key is stored in the memory M and can be read by the calculator D when the calculator is called for displaying the identification code. The key and the piece of time data transmitted via the connection 14 may be input data of an algorithm that can generate a valid identification code.

In other embodiments, the identification code contains N digits and is not limited to three digits.

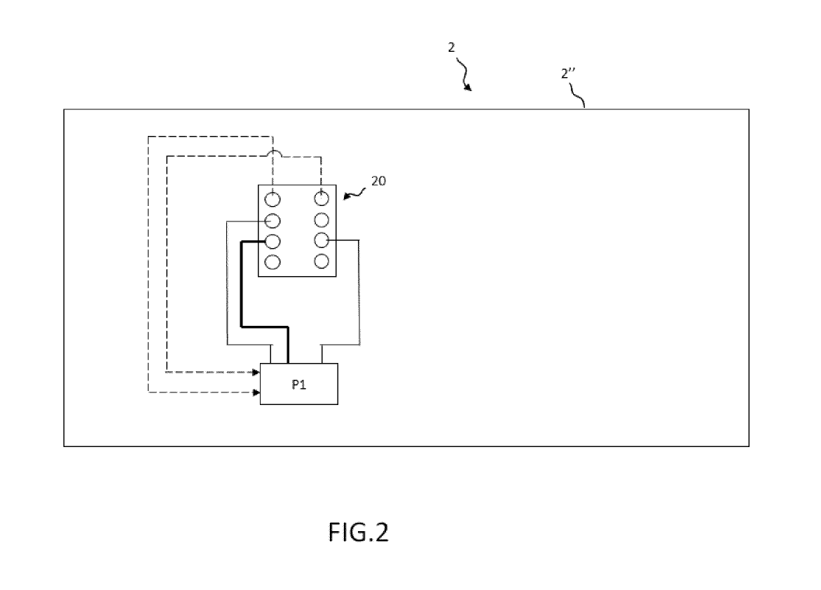

FIG. 2 is illustrated for information to represent a back 2″ of a smart card 2. The smart card 2 comprises a microchip P1 and an interface 20 comprising contacts as defined in the standard ISO7816. Some elements associated with the microchip are not represented, such as for example the associated memories.

A smart card 2 of the invention thus makes it possible to place the communication device of the invention on the back, that is on the other side of the card comprising the microchip that is traditionally placed on the front.

The invention makes it possible to:
optimally solve, from the standpoint of complexity of the solution and usage, the loading of information in a CVV code generation module;
facilitate the manufacturing of a card and reduce its cost;
provide additional security for the CVV at a lower cost.

1. A communication device comprising:
a memory for storing a numeric key and a diversification algorithm;
a calculator for generating an identification code from at least the numeric key and the diversification algorithm;
a display for displaying an identification code generated by the calculator, and
a light sensor for receiving and/or detecting light.

2. The communication device according to claim 1, wherein the light sensor is intended to receive a light signal, where the communication device provides a device initialisation function, which initialisation function operable to cause the communication device to
decode a sequence of data modulating a light signal received by the light sensor;
store the numeric key included in the decoded numeric sequence.

3. The communication device according to claim 1, where the calculator makes it possible to provide:
a function of activating the display after the acquisition of the light intensity received by the light sensor for a predefined time.

4. The communication device according to claim 1, wherein said communications device comprises a battery operable to supply power to the display and calculator.

5. The communication device according to claim 1, where the calculator operable to generate the identification code from a public piece of data and the numeric key stored in the memory.

6. The communication device according to claim 5, where said communication device comprises a clock for providing a date, wherein said date defines the public piece of data.

7. The communication device according to claim 1, which comprises a clock for determining time intervals in which the display allows the display of the identification code generated by the calculator, wherein said identification code is displayed after a predetermined security time elapses after the light is detected.

8. The communication device according to claim 3, where a new identification code is generated periodically.

9. The communication device according to claim 3, where the display of the identification code is maintained on the display during a display time.

10. A smart card comprising:
a communication device having:
a memory for storing a numeric key and a diversification algorithm;
a calculator for generating an identification code from at least the numeric key and the diversification algorithm;
a display for displaying an identification code generated by the calculator, and
a light sensor for receiving and/or detecting light.

11. The smart card according to claim 10, where the display is positioned on the same side of the card as the light sensor.

12. A method of carrying out a transaction from a smart card including a device having:
a memory for storing a numeric key and a diversification algorithm;
a calculator for generating an identification code from at least the numeric key, where the numeric key defines a piece of private data;
a display for displaying an identification code generated by the calculator;
a light sensor for receiving and/or detecting light, the method comprises:
positioning of the smart card so that the light sensor is exposed to a light source for a minimum time; and
displaying of an identification code on the display after the exposure for the minimum time.

13. A method for personalising a smart card comprising a card number, the method comprises:
allocating a communication device to a card number, where an identifier of said communication device is stored on a remote server and is associated with said card number, the communication device having:
a memory for storing a numeric key and a diversification algorithm;
a calculator for generating an identification code from at least the numeric key and the diversification algorithm;
a display for displaying an identification code generated by the calculator, and
a light sensor for receiving and/or detecting light;
installing the communication device on said smart card;
allocating a numeric key to a communication device associated with a card number; and
transferring the numeric key by the reception on the light sensor of a light signal modulated by a sequence of data during the final personalisation of the smart card.
